(19) United States
(12) Patent Application Publication
(10) Pub. No.: US 2010/0178433 A1
(43) Pub. Date: Jul. 15, 2010

(54) METHOD AND APPARATUS FOR APPLYING BONDING ADHESIVE

(75) Inventors: Pei-Chung Wang, Shanghai (CN); Paul E. Crittenden, Metamora, MI (US); John D. Fickes, Brighton, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/353,423

(22) Filed: Jan. 14, 2009

(51) Int. Cl. B05D 3/06; B05C 5/00

(52) U.S. Cl. 427/545; 118/300; 427/573

(57) ABSTRACT

A dispensing apparatus for dispensing adhesive includes an adhesive source and a dispensing member. The dispensing member is movably attached to the adhesive source. A dispensing nozzle is located on the dispensing member to dispense adhesive onto a component. A heating element is also located on the dispensing member to heat the component. Finally, a roller element is located on the dispensing member to apply pressure to the adhesive.

### TECHNICAL FIELD

The present invention relates, generally, to bonding adhesives, and more specifically, to a method and apparatus for applying adhesive to a material.

### BACKGROUND OF THE INVENTION

Bonding adhesives are commonly used with automotive vehicles to bond components of the vehicle together. In particular, bonding adhesives are used to attach sheet metal components for the vehicle to the vehicle body. The bonding adhesive is applied to the sheet metal components with dispensing machines. The bonding adhesive is applied to the components at the assembly plant, prior to placing the sheet metal components on the vehicle body.

The components are prepared ahead of time and shipped to the plant for assembly. The sheet metal is precut to the desired shape and size for the intended function of the sheet, i.e. a vehicle door, a vehicle roof, etc. To prevent the sheet metal component from rusting prior to vehicle assembly coatings are often applied to the surface of the material during the preparation of the components. In addition, lubricants are applied to the sheet metal to prevent the components from clinging to one another during shipping and prior to assembly. As a result of the lubricant and other contaminants being in contact with the material, when the bonding adhesive is applied to the sheet metal the adhesive can sag or drop off the sheet prior to the components being assembled on the vehicle body. This is especially common for components that are vertically oriented during application of the bonding adhesive, e.g. a vehicle door.

Furthermore, a component is often delayed from application to the vehicle body after the adhesive has been applied. For example, the adhesive is applied at the end of a working day and must wait until the next day before the assembly line moves the vehicle body into the proper place to adhere the component thereon. These delays provide additional opportunity for the adhesive to slump or drop off of the components.

### SUMMARY OF THE INVENTION

An arrangement for applying bonding adhesive to a vehicle component that has improved resistance to adhesive slumping on the vehicle component is desired.

A dispensing apparatus for dispensing adhesive includes an adhesive source and a dispensing member. The dispensing member is movably attached to the adhesive source. A dispensing nozzle is located on the dispensing member to dispense adhesive onto a component. A heating element is also located on the dispensing member to heat the component. Finally, a roller element is located on the dispensing member to apply pressure to the adhesive.

A method of dispensing the adhesive on the component includes at least heating the component with the heater element to remove contaminants from a surface of the component and dispensing adhesive from the dispenser nozzle onto the component

The above features and advantages, and other features and advantages of the present invention will be readily apparent from the following detailed description of the preferred embodiments and best modes for carrying out the present invention when taken in connection with the accompanying drawings.

### BRIEF DESCRIPTION OF THE DRAWINGS

FIG. 1 is a schematic perspective view of a first embodiment of a dispensing apparatus and a component;

FIG. 2 is a schematic perspective view of a component for the dispensing apparatus of FIGS. 1;

FIG. 3 is a schematic perspective view of a second embodiment of a dispensing apparatus and a component;

FIG. 4A is a cross-sectional view of a first embodiment for a dispenser nozzle for the dispensing apparatus of FIGS. 1 and 3;

FIG. 4B is a bottom view of the first embodiment for the dispenser nozzle of FIG. 4A;

FIG. 5A is a cross-sectional view of a second embodiment for a dispenser nozzle for the dispensing apparatus of FIGS. 1 and 3;

FIG. 5B is a bottom view of the second embodiment for the dispenser nozzle of FIG. 5A;

FIG. 6A is a cross-sectional view of a third embodiment for a dispenser nozzle for the dispensing apparatus of FIGS. 1 and 3;

FIG. 6B is a bottom view of the third embodiment for the dispenser nozzle of FIG. 6A;

FIG. 7A is a cross-sectional view of a fourth embodiment for a dispenser nozzle for the dispensing apparatus of FIGS. 1 and 3; and

FIG. 7B is a bottom view of the fourth embodiment for the dispenser nozzle of FIG. 7A.

### DESCRIPTION OF THE PREFERRED EMBODIMENTS

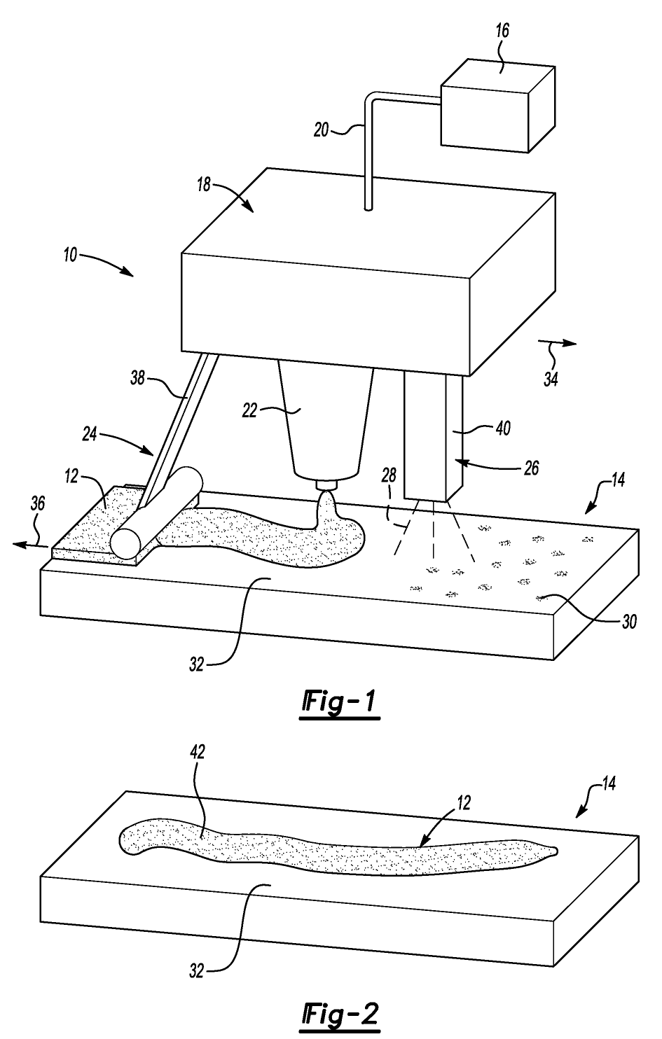

Referring to the Figures, wherein like reference numbers refer to the same or similar components throughout the several views, FIG. 1 schematically illustrates a dispensing apparatus 10 for applying adhesive 12 to a component 14. The dispensing apparatus 10 includes an adhesive source 16 and a dispenser member 18. The adhesive source 16 may be remotely connected to the dispenser member 18 through a flexible connecting member 20, as schematically shown. For example, the flexible connecting member 20 may be tubing to allow adhesive 12 to move from the adhesive source 16 to the dispenser member 18. The flexible connecting member 20 allows the dispenser member 18 to move relative to the adhesive source 16 to assist in application of the adhesive 12 to the component 14, as described below.

The dispenser member 18 includes a dispenser nozzle 22 to apply the adhesive 12 to the component 14. Additionally, the dispensing member 18 includes a roller element 24 on one side of the dispenser nozzle 22 and a heating element 26 on an opposing side of the dispenser nozzle 22. The roller element 24 applies pressure to the adhesive 12 once the adhesive is on the component 14. The heating element 26 provides heat 28 to the component 14 prior to applying the adhesive 12 to the component 14. The heat 28 burns, dries or evaporates contaminants 30 from the surface of the component 14 to provide a clean surface 32 for applying the adhesive 12. In the embodiment shown the heater element 40 is a blower or a knife-edge heater.

In operation, the dispensing member 18 may move relative to the component 14, as indicated by arrow 34, or the component 14 may move relative to the dispensing member 18, as indicated by arrow 36. The dispensing apparatus 10 component 14 and assembly environment would determine whether the component 14 or dispensing member 18 is moved in order to apply the adhesive 12. In both instances, the heating element 26 applies heat 28 to the component 14. Subsequently, the dispensing nozzle 22 applies the adhesive 12 to the component 14 and then the roller element 24 applies pressure to the adhesive 12. The roller element 24 only needs to apply enough pressure to the adhesive 12 to ensure sufficient contact between the adhesive 12 and the component 14 to retain and properly spread the adhesive 12 on the component 14. That is, enough pressure is applied to the adhesive 12 to ensure the contact between the adhesive 12 and the component 14 is enough to sustain the weight of the adhesive 12 on the component 14 until further assembly can occur.

The distance between the dispensing nozzle 22 and the component 14 is determined by several factors including the type of adhesive 12 to be applied to the component 14. One skilled in the art would know the proper adhesive 12 and distance between the dispensing nozzle 22 and the component 14 for a particular application. Based upon the determined distance between the dispensing nozzle 22 and the component 14 a roller arm 38 and a heater arm 40 may be adjusted in length, accordingly.

The distance between the dispensing nozzle 22 and the heater element 26 may vary depending on the application and arrangement of the dispensing nozzle 22. A minimum distance between the heater element 26 and the dispensing nozzle 22 would be based upon the ability of the component 14 to dissipate the heat 28 after the contaminants 30 are removed. For example, if the component 14 is sheet metal a minimal distance would be required between the heater element 26 and the dispensing nozzle 22 as the sheet metal would quickly dissipate the heat 28. No maximum distance is required as long as the heater element 26 is located prior to the dispensing nozzle 22.

Additionally, the distance between the roller element 24 and the dispensing nozzle 22 may vary as long as the dispensing nozzle is located prior to the roller element 24. Therefore, the size of the dispensing member 18 may be varied as required by the application and the conditions the dispensing member 18 is used under. One skilled in the art would be able to determine an optimal size for the dispensing member 18 based upon the conditions and applications for use.

FIG. 2 illustrates an example of a component 14 having a bead 42 of adhesive 12. The pressure on the bead 42 by the roller arm 38 (shown in FIG. 1) is enough to create sufficient contact between the adhesive 12 and the component 14 without unduly effecting the “wet-out” of the bead 42. Wet-out refers to the change in size of the bead 42 on the component 14 when pressure is applied.

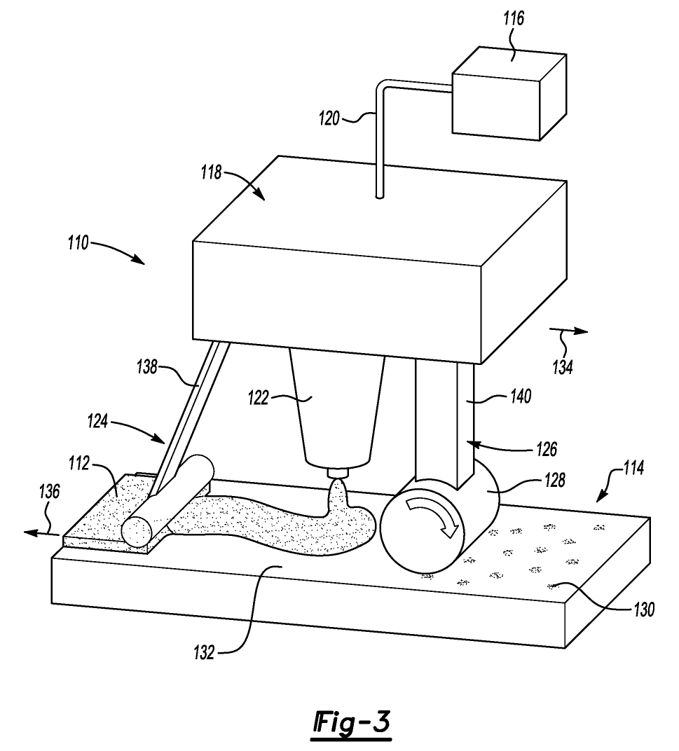

FIG. 3 schematically illustrates another embodiment of a dispensing apparatus 110 for applying adhesive 112 to a component 114. The dispensing apparatus 110 includes an adhesive source 116 and a dispenser member 118. The adhesive source 116 may be remotely connected through a flexible connecting member 120, as schematically shown. The flexible connecting member 120 allows the dispenser member 118 to move relative to the adhesive source 116 to assist in application of the adhesive 112 to the component 114.

The dispenser member 118 includes a dispenser nozzle 122 to apply the adhesive 112 to the component 114. Additionally, the dispensing member 118 includes a roller element 124 on one side of the dispenser nozzle 122 and a heating element 126 on an opposing side of the dispenser nozzle 122. The roller element 124 applies pressure to the adhesive 112 once the adhesive 112 is on the component 114. The heating element 126 provides heat 128 to the component 114 prior to applying the adhesive 112 to the component 114. Based upon the desired distance between the dispensing nozzle 122 and the component 114 a roller arm 138 and a heater arm 140 may be adjusted in length, accordingly.

The heat 128 burns or evaporates the contaminants 130 from the surface of the component 114 to provide a clean surface 132 for applying the adhesive 112. In the embodiment shown the heater element 126 is a resistance heater. If the component 114 is a conductive material, the heating element 126 may be a copper roller used to conduct a current to the component 114 to create heat 128. By varying a current magnitude, application time and electrode force of the heating element 126 joule heat is created and controlled. The heat 128 created can burn, dry or decompose the contaminants.

In operation the dispensing member 118 may move relative to the component 114, as indicated by arrow 134, or the component 114 may move relative to the dispensing member 118, as indicated by arrow 136. In both instances, the heating element 126 applies heat 128 to the component 114. Subsequently, the dispensing nozzle 122 applies the adhesive 112 to the component 114 and then the roller element 124 applies pressure to the adhesive 112. The roller element 124 applies pressure to ensure sufficient contact between the adhesive 112 and the component 114 to retain the adhesive 112 on the component 114.

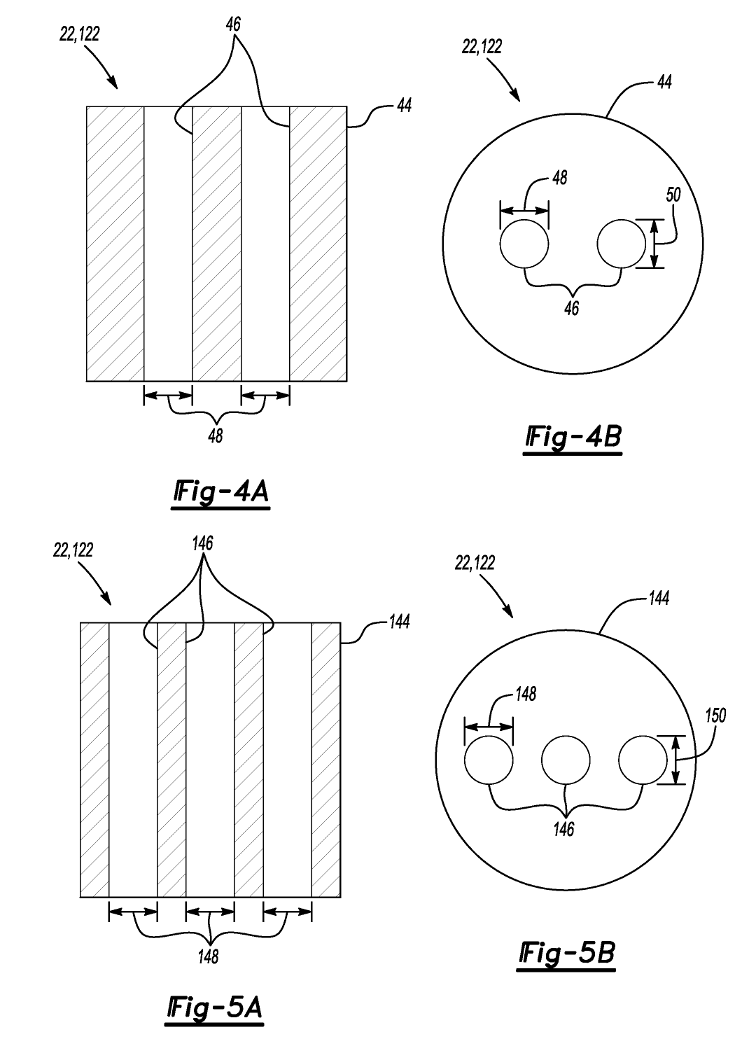

FIGS. 4A and 4B illustrate one embodiment for a dispensing nozzle 22, 122 for use with the dispensing apparatus 10, 110 (shown in FIGS. 1 and 3). The dispensing nozzle 22, 122 has a dispensing column 44. The dispensing column 44 defines a plurality of dispensing tubes 46 through which the adhesive 12, 112 (shown in FIGS. 1 and 3) may travel. In the embodiment shown, there are two dispensing tubes 46 which each have a generally circular shape. Each of the dispensing tubes 46 would create an adhesive bead 42 (shown in FIG. 2). The dispensing tubes 46 each have a width 48 and a height 50. The width 48 and the height 50 of the dispensing tube 46 determine the shape for each bead 42 of the adhesive 12, 112. For example, a width to height ratio for an adhesive bead 42 typically ranges from 1:1 up to 5:1. Therefore, the dispensing tubes 46 may have a width 48 to height 50 ratio ranging from 1:1 up to 5:1. Other width to height ratios may be achieved by varying the width 48 and height 50 of the dispensing tubes 46. One skilled in the art would be able to determined the appropriate width to height ratio based upon the combination of the dispensing nozzle 22, 122 and the adhesive 12, 112 to be used.

Further, several factors determine the overall size of the dispensing tubes 46. For example, the size of the dispensing tubes 46 may vary depending on; the type of adhesive 12, 112, the size of the component 14, 114 (shown in FIGS. 1 and 3) and the environment condition the dispensing nozzle 22, 122 is located.

FIGS. 5A and 5B illustrate another embodiment for a dispensing nozzle 22, 122 for use with the dispensing apparatus 10, 110 (shown in FIGS. 1 and 3). The dispensing nozzle 22, 122 has a dispensing column 144. The dispensing column 144 defines a plurality of dispensing tubes 146 through which the adhesive 12, 112 (shown in FIGS. 1 and 3) may travel. In the embodiment shown, there are three dispensing tubes 146 which each have a generally circular shape. Each of the dispensing tubes 146 would create an adhesive bead 42 (shown in FIG. 2). The dispensing tubes 146 each have a width 148 and a height 150. The width 148 and the height 150 of the dispensing tube 146 determine the shape for each bead 42 of the adhesive 12, 112. One skilled in the art would be able to determined the appropriate width to height ration based upon the combination of the dispensing nozzle 22, 122 and the adhesive 12, 112 to be used. Three dispensing tubes 146 may be used to apply the same overall amount of adhesive 12, 112 to a smaller component 14, 114 (shown in FIGS. 1 and 3) than the dispensing tubes 46 of FIGS. 4A and 4B. The dispensing tubes 146 may also reduce the cycle time (i.e., time spent in each production cell) and/or improve the wet-out of the adhesive 12, 112.

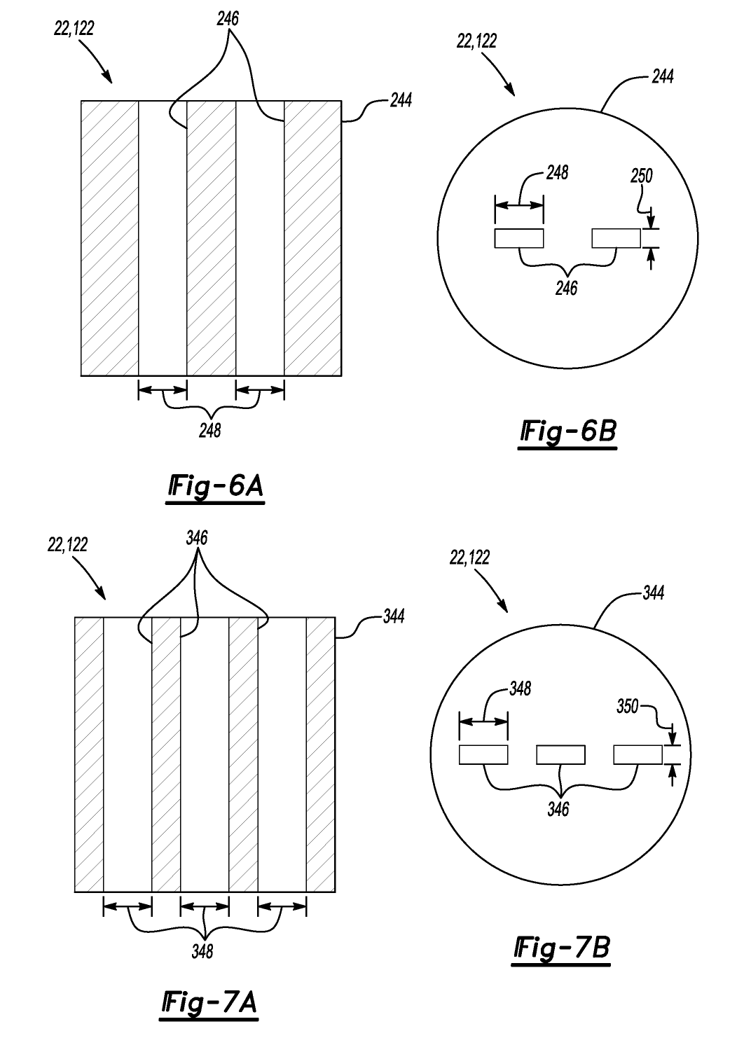

FIG. 6A and 6B illustrate another embodiment for a dispensing nozzle 22, 122 for use with the dispensing apparatus 10, 110 (shown in FIGS. 1 and 3). The dispensing nozzle 22, 122 has a dispensing column 244. The dispensing column 244 defines a plurality of dispensing tubes 246 through which the adhesive 12, 112 (shown in FIGS. 1 and 3) may travel. In the embodiment shown, there are two dispensing tubes 246 which each have a generally rectangular shape. Each of the dispensing tubes 246 would create an adhesive bead 42 (shown in FIG. 2). The dispensing tubes 246 each have a width 248 and a height 250. The width 248 and the height 250 of the dispensing tube 246 determine the shape for each bead 42 of the adhesive 12, 112. For example, a width to height ratio for an adhesive bead 42 typically ranges from 1:1 up to 5:1. Therefore, the dispensing tubes 246 may have a width 248 to height 250 ratios ranging from 1:1 up to 5:1. Other width to height ratios may be achieved by varying the width 248 and height 250 of the dispensing tubes 246. One skilled in the art would be able to determine the appropriate width to height ration based upon the combination of the dispensing nozzle 22, 122 and the adhesive 12, 112 to be used.

Further, several factors determine the overall size of the dispensing tubes 246. For example, the size of the dispensing tubes 246 may vary depending on the type of adhesive 12, 112, the size of the component 14, 114 (shown in FIGS. 1 and 3) and the environment condition the dispensing nozzle 22, 122 is located.

FIGS. 7A and 7B illustrate another embodiment for a dispensing nozzle 22, 122 for use with the dispensing apparatus 10, 110 (shown in FIGS. 1 and 3). The dispensing nozzle 22, 122 has a dispensing column 344. The dispensing column 344 defines a plurality of dispensing tubes 346 through which the adhesive 12, 112 (shown in FIGS. 1 and 3) may travel. In the embodiment shown, there are three dispensing tubes 346 which each have a generally rectangular shape. Each of the dispensing tubes 346 would create an adhesive bead 42 (shown in FIG. 2). The dispensing tubes 346 each have a width 348 and a height 350. The width 348 and the height 350 of the dispensing tube 346 determine the shape for each bead 42 of the adhesive 12, 112. Three dispensing tubes 346 may be used to apply the same overall amount of adhesive 12, 112 to a smaller component 14, 114 (shown in FIGS. 1 and 3) than the dispensing tubes 246 of FIGS. 4A and 4B.

While the best modes for carrying out the invention have been described in detail, those familiar with the art to which this invention relates will recognize various alternative designs and embodiments for practicing the invention within the scope of the appended claims.

1. A dispensing apparatus for dispensing adhesive comprising:
an adhesive source;
a dispensing member movably attached with respect to the adhesive source;
a dispensing nozzle located on the dispensing member to dispense adhesive onto a component;
a heating element located on the dispensing member to heat the component; and
a roller element located on the dispensing member to apply pressure to the adhesive.

2. The dispensing apparatus of claim 1, wherein the heating element is located on a first side of the dispensing nozzle and the roller element is located on an opposing side of the dispensing nozzle.

3. The dispensing apparatus of claim 1, wherein the heater element further comprises a blower.

4. The dispensing apparatus of claim 1, wherein the heater element further comprises an electrical resistor.

5. The dispensing apparatus of claim 1, wherein the dispensing nozzle further comprises at least one dispensing tube.

6. The dispensing apparatus of claim 5, wherein the at least one dispensing tube is generally circular in shape.

7. The dispensing apparatus of claim 5, wherein the at least one dispensing tube is generally rectangular in shape.

8. The dispensing apparatus of claim 5, wherein the at least one dispensing member comprises two dispensing tubes.

9. The dispensing apparatus of claim 5, wherein the at least one dispensing member comprises three dispensing tubes.

10. An apparatus for dispensing adhesive comprising:
an adhesive source;
a dispensing member movably attached with respect to the adhesive source;
a dispensing nozzle located on the dispensing member to dispense adhesive onto a component; and
a heating element located on the dispensing nozzle to apply heat to a component.

11. The apparatus of claim 10, further comprising a roller element located on the dispensing member to apply pressure to the adhesive.

12. The apparatus of claim 11, wherein the heating element is located on the dispenser member on a first side of the dispensing nozzle and the roller element is located on an opposing side of the dispensing nozzle.

13. The apparatus of claim 10, wherein the heater element further comprises a blower.

14. The apparatus of claim 10, wherein the heater element further comprises an electrical resistor.

15. The apparatus of claim 10, wherein the dispensing nozzle further comprises a plurality of dispensing tubes.

16. A method of dispensing adhesive on a component comprising:
heating the component with a heater element to remove contaminants from a surface of the component; and
dispensing adhesive from a dispenser nozzle onto the component.

17. The method of claim 16, further comprising:
applying pressure to the adhesive with a roller element to ensure contact between the adhesive and the component.

18. The method of claim 16, further comprising moving a dispenser member to move the heater element and the dispensing nozzle relative the component.

19. The method of claim 16, further comprising moving the component relative to a dispenser member to move the component relative to the heater element and the dispensing nozzle.
